(19) United States
(12) Patent Application Publication
(10) Pub. No.: US 2010/0026804 A1
(43) Pub. Date: Feb. 4, 2010

(54) Route guidance systems, methods, and programs

(75) Inventors: Daisuke Tanizaki, Chiryu (JP); Kiyohide Kato, Okazaki (JP)

Correspondence Address: OLIFF & BERRIDGE, PLC, P.O. BOX 320850, ALEXANDRIA, VA, 22320-4850, US

(73) Assignee: AISIN AW CO., LTD., ANJO-SHI (JP)

(21) Appl. No.: 12/149,066

(22) Filed: Apr. 25, 2008

(30) Foreign Application Priority Data
Apr. 27, 2007 (JP) 2007-119584

(51) Int. Cl. H04N 7/18; G01C 21/36; G06K 9/46

(52) U.S. Cl. 348/148; 701/201; 382/190; 348/E07.085

(57) ABSTRACT

Route guidance systems, methods, and programs detect a current position of a vehicle and search for a route to a destination based on the detected current position. The systems, methods, and programs identify a guide intersection along the route and set a route guide point at a predetermined point on the route before the guide intersection. The systems, methods, and programs calculate a number of intersections along the route from the route guide point to the guide intersection having both a traffic signal and a road feature and perform a voice output based on the calculated number of intersections when the vehicle arrives at the route guide point.

### INCORPORATION BY REFERENCE

The disclosure of Japanese Patent Application No. 2007-119584, filed on Apr. 27, 2007, including the specification, drawings and abstract thereof, is incorporated herein by reference in its entirety.

### BACKGROUND

1. Related Technical Fields

Related technical fields include route guidance systems, methods, and programs.

2. Description of the Related Art

Conventionally, in navigation devices using a global positioning system (GPS), a current position of a vehicle is detected, map data is read from a data recording unit, and a map screen is formed on a display unit. On the map screen, the location of the vehicle that indicates the current position, a neighborhood map, and the like are displayed. Accordingly, the driver can drive the vehicle according to the location of the vehicle displayed on the map screen, and the like.

If the driver inputs a destination and sets search conditions, a route search is performed based on the search conditions. Then, based on the map data, a route from a departure point to the destination is searched. The searched route is displayed on the map screen together with the location of the vehicle and route guidance is performed. According to the route guidance, the driver can drive the vehicle.

During the route guidance, if it is necessary to turn the vehicle to the left or right at a certain intersection, before the vehicle arrives at the intersection (“guide intersection”) voice guidance is output. Accordingly, at points before the guide intersection on the searched route one or more route guide points are set at predetermined distances. When the vehicle arrives at each route guide point, predetermined guidance set for the route guide points is vocally output (see, e.g., Japanese Unexamined Patent Application Publication No. 2003-121185). In the conventional navigation devices, at each route guide point, route guidance about the guide intersection is performed based on the number of intersections that are provided with traffic signals, that is, intersections with traffic signals existing between the location of the vehicle and the guide intersection.

### SUMMARY

At an intersection, an oncoming lane may have a road to enter into the intersection and a road to exit from the intersection while a travel lane, may not have a road to enter and a road to exit. In a conventional navigation device, the intersection may be recognized as an intersection with traffic signals, even though the signals are only for the oncoming lane, not the travel lane. In this case, the driver may become confused, and the driver may mistakenly recognize the guide intersection.

FIG. 2 is a view illustrating route guidance in a known navigation device. In the drawing, pr denotes a location of a vehicle, ri (i=1 to 4) denotes roads, crj (j=1 to 3) denotes intersections where predetermined two or more roads intersect, sgj (j=1 to 3) denotes traffic signals, and km (m=1 to 10) denotes lanes. ej (j=1 to 3) denotes stop lines provided on predetermined lanes km at each of the intersections crj, and Zn denotes a median strip provided on road r1. Rt1 denotes a searched route, and h1 denotes a route guide point that is set on the searched route Rt1. On the searched route Rt1, the vehicle is to be guided to pass the road r1, to turn left at an intersection cr3. Thus, the intersection cr3 is the guide intersection.

In this case, at the intersections cr1 and cr3, roads to enter and roads to exit are provided on both of the travel lane and an oncoming lane. However, at the intersection cr2, the travel lane and the oncoming lane are divided by the median strip Zn. To the oncoming lane, a road r3 is connected and thus a road to enter and a road to exit are provided. On the other hand, for the travel lane, a road to enter and a road to exit are not provided at intersection r3.

Accordingly, if the intersection cr2 is recognized as an intersection with traffic signals by the navigation device, during the travel along the searched route Rt1, at the route guide point h1, for example, a guidance phrase “Make a left turn at the third intersection with traffic signals,” or the like is output. Based on such a phrase, is hard for the driver to determine which intersection is the “the third intersection with traffic signals,” and may misidentify the guide intersection.

Various exemplary implementations of the broad principles described herein provide route guide systems, methods, and programs that enable a driver to more easily recognize a guide intersection.

Exemplary implementations provide systems, methods, and programs that detect a current position of a vehicle and search for a route to a destination based on the detected current position. The systems, methods, and programs identify a guide intersection along the route and set a route guide point at a predetermined point on the route before the guide intersection. The systems, methods, and programs calculate a number of intersections along the route from the route guide point to the guide intersection having both a traffic signal and a road feature and perform a voice output based on the calculated number of intersections when the vehicle arrives at the route guide point.

### BRIEF DESCRIPTION OF THE DRAWINGS

Exemplary implementations will now be described with reference to the accompanying drawings, wherein:

FIG. 1 is a view illustrating an exemplary navigation system;

FIG. 2 is a view illustrating route guidance in a known navigation device;

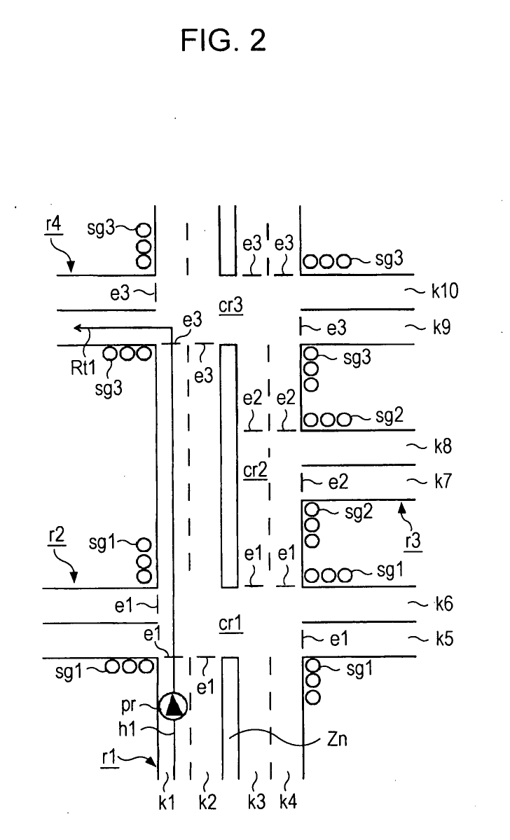

FIG. 3 is a flowchart illustrating an exemplary guidance method;

FIG. 4 is a view illustrating an example of route guidance; and

FIG. 5 is a view illustrating an example of route guidance.

### DETAILED DESCRIPTION OF EXEMPLARY IMPLEMENTATIONS

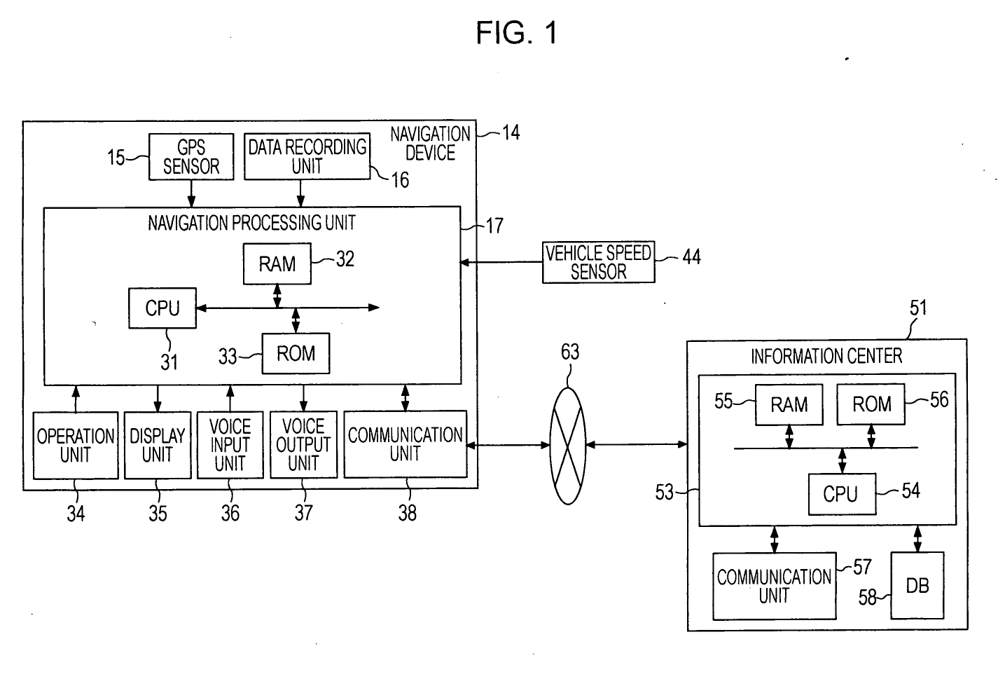

FIG. 1 shows an exemplary navigation system. As shown in FIG. 1, the exemplary navigation system includes an information terminal such as, for example, a navigation device 14 mounted on a vehicle, a network 63, and an information center 51.

The navigation system 14 includes a GPS sensor 15, a memory (data recording unit 16), a navigation processing unit 17, an operation unit 34, a display unit 35, a voice input unit 36, a voice output unit 37, and a communication unit 38. The GPS sensor 15 detects a current location of the vehicle and a direction the vehicle is traveling. The data recording unit 16 stores map data and various information. The navigation processing unit 17 performs various calculations and processes such as navigation processing. The operation unit 34 is operated by a driver or passenger to perform predetermined input. The display unit 35 displays images on a screen (not shown) to provide information to the driver. The voice input unit 36 allows input by a voice of the driver. The voice output unit 37 outputs a voice output to notify the driver. The communication unit 38 functions as a transmission/reception unit that functions as a communication terminal.

The GPS sensor 15, the data recording unit 16, the operation unit 34, the display unit 35, the voice input unit 36, the voice output unit 37, and the communication unit 38 are connected to the navigation processing unit 17. Further, a vehicle speed sensor 44 that detects a vehicle speed, and the like, is connected to the navigation processing unit 17. The GPS sensor 15 detects time in addition to the location and the direction of the vehicle. Further, an image capture device (e.g., a camera) may be provided at a predetermined location on the vehicle, such as, at a rear end of the vehicle.

The data recording unit 16 includes a map database that stores map data. In The map data includes various data such as intersection data about intersections (branch points), node data about nodes, road data about road links, search data that is processed for search, facility data about facilities, and feature data about road features. The map data further includes data for outputting predetermined information by the voice output unit 37.

The road features are indicators that are set or formed on roads to provide various travel information or various travel guides to drivers. The features include indication lines, road signs (paints), crosswalks, manholes, etc. The indication lines include stop lines to stop vehicles, vehicular lane borderlines that separate each lane, compartment lines that indicate parking spaces, etc. The road signs include traffic section signs that indicate traveling directions of each lane by arrows, guide signs that notify drivers of places to temporarily stop in advance such as “stop” or guide directions such as “toward **,” etc. The feature data includes positional information that indicates positions of each feature using coordinates, image information that shows each feature using images, etc. The places to temporarily stop include places to enter from secondary roads to main roads, crossings, intersections with flashing red traffic lights, etc. The road data about lanes include lane data that has lane numbers assigned for each lane on roads, positional information of the lanes, etc.

The data recording unit 16 further includes a statistical database that has statistical data files, a mileage history database that has mileage history data files, etc. In the statistical data files, the statistical data is recorded, and in the mileage history data files, the mileage history data is recorded as performance data.

The data recording unit 16 further includes a disc (not shown) such as a hard disc, a compact disc (CD), a Digital Versatile Disc (DVD), an optical disc, etc., to record the various data and a head (not show) such as a read/write head to read or write the various data. To the data recording unit 16, a memory card, etc. can be used. The disc, memory card, etc. form an external storage unit.

In the example, the data recording unit 16 includes the map database, the statistical database, the mileage history database, etc. However, the map database, the statistical database, the mileage history database, etc. can be provided in the information center 51.

The navigation processing unit 17 includes a controller (CPU 31), a Random Access Memory (RAM) 32, a Read-Only Memory (ROM) 33, a flash memory (not shown), etc. The CPU 31 functions as control device that controls entire navigation device 14, and also functions as a processing unit, and the RAM 32 is used as a working memory for the CPU 31 in performing various operations. The ROM 33 records a program for control and various programs for performing searching routes to destinations, route guidance, etc., and the flash memory object sound used to record various data, programs, etc. The RAM 32, the ROM 33, the flash memory, etc. form an internal storage unit.

As the operation unit 34, a keyboard, a mouse, and the like provided independently of the display unit 35 can be used. Further, as the operation unit 34, a touch panel configured to perform a predetermined input operation by touching or clicking image operation parts such as various keys, switches, buttons, etc. displayed by images on a screen formed on the display unit 35 can be used.

As the display unit 35, a display can be used. On various screens formed on the display unit 35, a location of the vehicle, a direction of the vehicle, etc. can be displayed. Further, on the screens, maps, searched routes, guide information and traffic information based on the maps, distances to next intersections on the searched routes, and directions to travel at the next intersections can be displayed.

The voice input unit 36 includes a microphone (not shown) and the like, and can input necessary audio information. The voice output unit 37 includes voice synthesis device (not shown) and a speaker (not shown) to output audio route guidance of the searched routes.

The communication unit 38 includes a beacon receiver, a frequency modulation (FM) receiver, etc. The beacon receiver receives various information such as traffic information and general information transmitted by a vehicle information center (not shown) such as a Vehicle Information and Communication System center (VICS®) as an information provider. The FM receiver receives FM multiplex broadcast via FM broadcast stations. The communication unit 38 can receive, in addition to the traffic information, the general information, etc. transmitted by the information center 51, the map data, the statistical data, the mileage history data, etc. via the network 63.

The information center 51 includes a server 53, a communication unit 57 that is connected to the server 53 and a database (DB) 58 that functions as an information recording unit, etc. The server 53 includes a controller (CPU 54) that functions as a control device and a processing unit, a RAM 55, a ROM 56, etc. In the database 58, data similar to the various data recorded in the data recording unit 16 is recorded.

The navigation system, the navigation processing unit 17, the CPU 31, the CPU 54, the server 53, etc. can function as single computers or computers by combining two or more of the components to perform operation processing based on the various program, data, etc. The data recording unit 16, the RAMs 32 and 55, the ROMs 33 and 56, the database 58, the flash memory, etc. form a recording medium. As the processing unit, in place of the CPUs 31 and 54, a micro processing unit (MPU), etc. can be used.

During basic operation of the above-described navigation system, a driver operates the operation unit 34 to activate the navigation device 14. In response to the activation, the CPU 31 reads a location and direction of the vehicle detected by the GPS sensor 15. Then, the CPU 31 performs map matching to specify the location of the vehicle on a particular road link based on the read track of the locations of the vehicle and shapes and arrangements of each road link that form roads around the vehicle.

In the example, the CPU 31 can also specify the location of the vehicle based on a location of a feature that is an object shot by the camera. For such a purpose, the CPU 31 performs an image recognition processing. In the processing, the CPU 31 reads image data from the camera and recognizes a feature in the image data. Further, the CPU 31 calculates a distance from the camera to the actual feature based on the location of the feature in the image. The CPU 31 then reads the distance, reads the feature data from the data recording unit 16, acquires coordinates of the feature, and specifies the location of the vehicle based on the coordinates and the distance.

The CPU 31 specifies the location of the vehicle, similarly, by matching the feature that is recognized based on the image data, the feature data read from the data recording unit 16, and lane data. Based on the specified location of the vehicle, a travel lane on which the vehicle is traveling is specified.

The CPU 31 can read a sensor output of a geomagnetic sensor (not shown). Based on the sensor output, the CPU 31 can determine whether an object to be detected formed of a ferromagnetic material such as a manhole exists on a predetermined lane on a road. Based on the determination result, the CPU 31 can determine the travel lane. Further, the CPU 31 can use a high-precision GPS sensor to precisely detect the location of the vehicle, and based on the detection result, detect the travel lane. Further, if necessary, the CPU 31 can specify the travel lane by combining the sensor output from the geomagnetic sensor, the location of the vehicle, and the like while performing an image processing on image data of an indication line.

The CPU 31 also reads and acquires the map data from the data recording unit 16, or receives and acquires the map data from the information center 51 or the like via the communication unit 38. In the case where the map data is acquired from the information center 51 or the like, the CPU 31 downloads the received map data in the flash memory.

The CPU 31 forms various screens on the display unit 35 and displays the location and direction of the vehicle on the map screen, and displays a neighbor map around the location of the vehicle. Accordingly, the driver can drive the vehicle based on the location and direction of the vehicle and neighbor map.

In response to the driver's operation to input a destination using the operation unit 34, the CPU 31 sets a destination. If necessary, it is also possible to input and set a departure place. It is also possible to register a predetermined place in advance and set the registered place as a destination. Then, in response to the driver's operation to input a search condition using the operation unit 34, the CPU 31 sets a search condition.

In response to the setting of the destination and the search condition, the CPU 31 reads the location of the vehicle, the destination, the search condition, etc. Then, the CPU 31 search data, etc. from the data recording unit 16, and based on the location of the vehicle, the destination, and the search data, searches for a route from the departure place to the destination with the search condition and outputs route data for the searched routes. In the searched routes, a route that has a minimum total cost of links allotted to each road link may be selected as the searched route.

Further, it is possible to perform the route search processing in the information center 51. In this case, the CPU 31 transmits the location of the vehicle, the destination, the search condition, etc. to the information center 51 via the network 63. In response to the reception of the location of the vehicle, the destination, the search condition, etc. in the information center 51, the CPU 54 performs a route search processing similar to that in the CPU 31, and reads search data, etc. from the database 58. Then, based on the location of the vehicle, the destination, and the route data, the CPU 54 searches for a route from the departure place to the destination with the search condition and outputs route data showing the searched route. Then, the CPU 54 transmits the route data to the navigation device 14 via the network 63.

The CPU 31 also performs route guidance. For the purpose, CPU 31 reads the route data, and based on the route data, displays the searched route on the map screen. In the route guidance, when it is necessary to turn the vehicle to the left or right at a predetermined intersection on the searched route, the intersection is set as a guide intersection, and route guidance for turning the vehicle to the left or right at the guide intersection is performed. Further, on toll roads for vehicles such as an expressway, an urban expressway, a toll road, etc., an intersection to merge into or branch from a junction, etc. can be set as the guide intersection. When the vehicle passes through a predetermined facility on the searched route, for example, a grade crossing, the grade crossing can be set as a guide facility, and route guidance for temporarily stop the vehicle at the guide facility can be performed. The CPU 31 based on route data, sets the guide intersection, the guide facility, etc. The guide intersection, the guide facility, etc. constitute guide points.

The CPU 31, then sets one or more route guide points before the guide intersection, the guide facility, etc. on the searched route. The guide points are spaced apart by predetermined distances. When the vehicle arrives at each route guide point, the CPU 31 performs voice outputs with guidance phrases of contents set in advance for each guide point about the guide intersection, the guide facility, etc.

Guidance phrases are set for each route guide point and the guidance phrases are recorded as a guidance phrase map in the data recording unit 16. The CPU 31t reads the locations of the guide intersection, the guide facility, etc. and the location of the vehicle, calculates distances from the location of the vehicle to the guide intersection, the guide facility, etc., and determines whether the vehicle approaches to the guide intersection, the guide facility, etc., and arrives at a predetermined route guide point. If the vehicle has arrived at the predetermined route guide point, the CPU 31 refers to the guidance phrase map, reads a guidance phrase corresponding to each distance, and performs a voice output.

The CPU 31 forms an enlarged view of the guide intersection, that is, an intersection enlarged view as a guide point enlarged view, at a predetermined area in the map screen before the vehicle arrives at the guide intersection, and performs a route guidance based on the intersection enlarged view. When the vehicle arrives at the point before (the side of the location of the vehicle) the guide intersection on the searched route and apart by the set distance, the intersection enlarged view is displayed. In this case, on the intersection enlarged view, a neighbor map of the guide intersection, the searched route, facilities that are landmarks at the guide intersection, etc., are displayed.

Further, in a case where a route that has a plurality of lanes is included in the searched route, the CPU 31 reads the searched route, reads intersection data, lane data, etc. Based on the searched route, intersection data, the lane data, etc., the CPU 31 calculates recommended lanes on each road and acquires lane numbers. Then, CPU 31 forms a lane guide map at a predetermined area in the map screen, displays each lane on the route on the lane guide map, displays the recommended lanes, and guide the vehicle from the travel lane to the recommended lane.

As described above, for example, if the route guide points are set before the guide intersection and the vehicle arrives at the route guide points, the route guidance about the guide intersection by the voice output is performed.

As discussed above, conventionally, in performing the route guidance based on the number of the intersections with traffic signals existing between the location of the vehicle and the guide intersection, if a branch road r3 exists on an oncoming lane and a road to enter and a road to exit exist, but a branch road does not exist on the travel lane and a road to enter and a road to exit are not provided, the intersection may be considered as an intersection having traffic signals for the travel lane. Then, if the number of the intersections is calculated, the route guidance is hard to understand for the driver, and the driver may misidentify the guide intersection.

Accordingly, in this example, in calculating the number of the intersections with traffic signals existing from the location of the vehicle to the guide intersection, feature data is used in addition to intersection data.

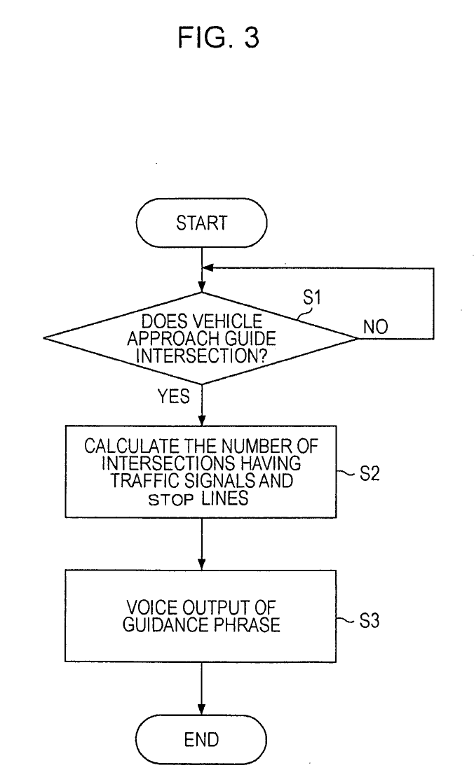

An exemplary guidance method will be described with reference to FIG. 3-FIG. 5. The exemplary method may be implemented, for example, by one or more components of the above-described system. For example, the method may be implemented by a program stored in the RAM, ROM, or the like included in the navigation processing unit 17 or the server 53, and is executed by the CPU 31 or the CPU 54. However, even though the exemplary structure of the above-described system may be referenced in the description, it should be appreciated that the structure is exemplary and the exemplary method need not be limited by any of the above-described exemplary structure.

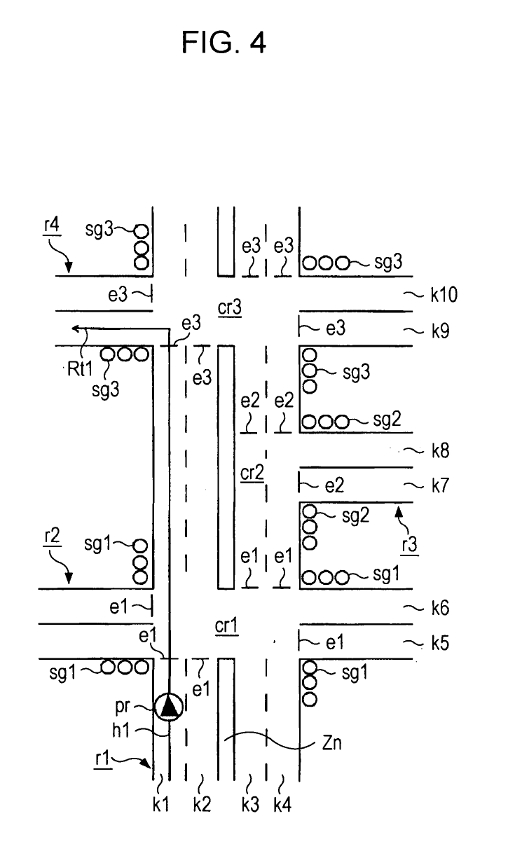

In FIG. 4, pr denotes a location of the vehicle, ri (i=1 to 4) denotes roads, crj (j=1 to 3) denotes intersections where predetermined two or more roads intersect, and sgj (j=1 to 3) denotes traffic signals provided at each of the intersections crj. km (m=1 to 10) denotes lanes, ej (j=1 to 3) denotes stop lines formed on the predetermined lanes km at each of the intersections crj, and Zn denotes a median strip provided on a road r1. Rt1 denotes a searched route, and h1 denotes a route guide point that is set on the searched route Rt1. On the searched route Rt1, the vehicle is to be guided to pass the road r1, and turn left at an intersection cr3, and then. Thus, the intersection cr3 is the guide intersection.

In this case, at the intersections cr1 and cr3, there are roads to enter and roads to exit on both the travel lane and the oncoming lane. That is, if the vehicle travels on the lane k1 or k2, at the intersection cr1, the road r1 is the road to enter, and the road r2 is the road to exit. At the intersection cr3, the road r1 is the road to enter, and the road r4 is the road to exit. If the vehicle travels on the lane k3 or k4, at the intersection cr3, the road r1 is the road to enter, and the road r4 is the road to exit. At the intersection cr1, the road r1 is the road to enter, and the road r2 is the road to exit. Accordingly, at the intersections cr1 and cr3, on both of the travel lane and the oncoming lane, the stop lines e1 and e3 exist before the inter sections cr1 and cr3.

On the other hand, at the intersection cr2, the travel lane and the oncoming lane are divided by the median strip. To the oncoming lane, the road r3 is connected and there is a road to enter and a road to exit. However, on the travel lane, a road to enter and a road to exit do not exist. That is, if the vehicle travels on the lane k1 or k2, at the intersection cr2, the vehicle can travel only in a straight direction. On the other hand, if the vehicle travels on the lane k3 or k4, at the intersection cr2, the road r1 is the road to enter and the road r3 is the road to exit. Accordingly, at the intersection cr2, a stop line is not provided before the intersection cr2 on the travel lane, and a stop line e2 only exists before the intersection cr2 on the oncoming lane.

As described above, on the searched route Rt1, at the intersection that has the road to enter and the road to exit, the stop line exists. However, at the intersection that does not have the road to enter and the road to exit, a stop line is not provided.

In the guidance method, first, the CPU 31 reads a location of a guide intersection and a location of an the vehicle pr, calculates a distance from the location of the vehicle pr to the location of the guide intersection, and determines whether the vehicle approaches to the guide intersection (S1) and arrives at a predetermined route guide point h1. If the vehicle arrives at the predetermined route guide point h1 (S1=YES), CPU 31 reads intersection data and feature data, and calculates the number of intersections crj that have traffic signals sgj and stop lines ej from the route guide point h1 to the guide intersection cr3 (S2) as the number of intersections with traffic signals.

Specifically, the CPU 31 sequentially determines whether traffic signals exist with respect to each of the intersections cr1 to cr3 on the searched route Rt1. If there are the traffic signals, it is then determined whether stop lines ej exist on the road to enter before the intersections crj on the travel lane. If, at an intersection crj, there are stop lines ej on the travel lane before the intersection, the intersection is counted towards the number of intersections being calculated.

In the example shown in FIG. 4, at all of the intersections cr1 to cr3 in the intersections crj from the route guide point h1 to the guide intersection, there are traffic signals sg1 to sg3 respectively. However, on the travel lane (the side of the lanes k1 and k2), there are stop lines e1 and e3 on the road to enter before the intersections cr1 and cr3, but there is not a road to enter before the intersection cr2, and thus there is not a stop line at intersection cr2. Accordingly, the intersections cr1 and cr3 are counted, and intersection cr2 is not counted. Thus, the total number of the intersections with traffic signals sgj and stop lines ej is two.

Next, the CPU 31 reads the calculated number of intersections, refers to the guidance phrase map, and reads the guidance phrases corresponding to the calculated number of the intersections and distances. Then, the CPU 31 performs voice output of guidance phrases (S3) such as “Make a left turn at the second traffic signal,” or the like.

Using the route guidance by the voice outputs, the driver drives the vehicle according to the route guidance from the location of the vehicle pr to the guide intersection along the searched route Rt1.

As described above, in the example, based on the traffic signals sgj and features (e.g., stop lines ej) on the searched route Rt1 from the route guide point h1 to the guide intersection, the number of the intersections in the travel lane is more accurately calculated. Based on the calculated number of the intersections, the route guidance is performed. Accordingly, the driver can more easily determine which intersection is the guide intersection announced by the guidance phrase.

In the above example, the number of the intersections crj is calculated based on the intersection data and the feature data. However, if the vehicle is actually driven along the searched route Rt1, a new traffic signal may be installed at a predetermined intersection crj and a new stop line may be provided. In this case, when the vehicle passes through the intersection, the stop line is shot by the camera. Then, the CPU 31 reads the image data from the camera, and recognizes the stop line in the image data. The CPU 31 then may notify the driver that the traffic signal is newly installed and the stop line is provided. Accordingly, the driver can correctly recognize the guide intersection in spite of the newly installed intersection. In such a case, the CPU 31 adds the data of the newly installed traffic signal to the intersection data, adds the data of the newly provided stop line to the feature data, and updates the data.

It is possible that two or more intersections may be integrated because, for example, the intersections are close to each other. In this case, the integrated intersection may be recorded in the data recording unit 16 as one intersection, and may be considered as one intersection in route search and guidance.

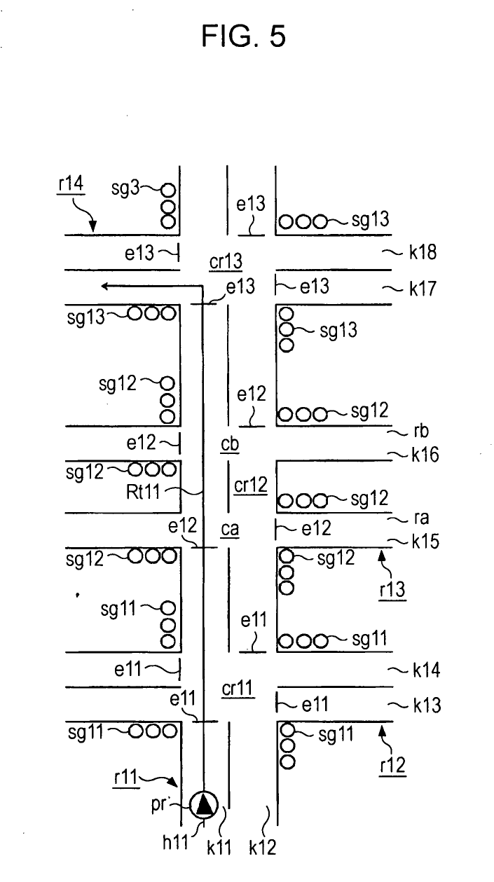

An example of such an integrated intersection is shown in FIG. 5. In FIG. 5, pr denotes a location of the own vehicle, ri (i=11 to 14) denotes roads, crj (j=11 to 13) denotes intersections where two or more roads intersect, and sgj (j=11 to 13) denotes traffic signals provided at each of the intersections crj. km (m=11 to 18) denotes lanes, ej (j=11 to 13) denotes stop lines formed on predetermined lanes km at the intersections crj. Rt11 denotes a searched route, and h11 denotes a route guide point that is set on the searched route Rt11. On the searched route Rt11, the vehicle is to be guided to pass the road r11, and turn left at an intersection cr13 (the guide intersection).

The route r13 is formed of two separate roads ra and rb provided in parallel. The intersection cr12, where route r13 intersects route r11 includes two intersections ca and cb that are closely provided. At the intersection ca, the roads r11 and road ra are intersect with each other, and at the intersection cb, the roads r11 and the road rb are intersect with each other. The intersection cr12 is thus an integrated intersection. In this case, the road ra and rb may be one-way roads or two-way roads. In the example, the road ra and rb are one-way roads.

At the intersection cr12, traffic signals sg12 are provided at each of the intersections ca and cb. However, the intersections ca and cb are considered as one integrated intersection cr2. Accordingly, at the intersection cr2, there is the stop line e12 before the intersection ca on the travel lane, but there is not a stop line before the intersection cb on the travel lane. Further, there is the stop line e12 before the intersection cb on the oncoming lane, but there is not a stop line before the intersection ca on the oncoming lane.

Now, an example of the guidance method where a vehicle is driven along the searched route Rt11 is described. First, the CPU 31 reads a location of a guide intersection and a location of the vehicle pr, calculates a distance from the location of the vehicle pr to the location of the guide intersection, and determines whether the vehicle approaches to the guide intersection (S1) and arrives at a predetermined route guide point h11. If the vehicle arrives at the predetermined route guide point h11 (S1=YES), the CPU 31 reads the intersection data and the feature data, and calculates the number of intersections that have traffic signals sgj and stop lines ej out of the intersections crj from the route guide point h11 to the guide intersection (S2).

Specifically, the CPU 31 sequentially determines whether traffic signals exist with respect to each of the intersections cr11 to cr13 on the searched route Rt11. If there are traffic signals, it is then determined whether stop lines ej exist on the road to enter before the intersections crj on the travel lane. If there is a stop line ej on the travel lane before an intersections crj, the intersection is counted towards the calculated number of intersections.

In the example shown in FIG. 5, there are the traffic signals sg11 to sg13 at all of the intersections cr11 to cr13 from the route guide point h11 to the guide intersection. On the travel lane (the side of the lanes k11 and k12), there are stop lines e11 and e13 on the road to enter before the intersections cr11 and cr13. However, at the intersection cr12, there is stop line e12 before the intersection ca but there is not a stop line before the intersection cb.

Accordingly, the number of the intersections cr11 and cr13 is counted, and with respect to the intersection cr12, only intersection ca is counted and intersection cb is not counted. Accordingly, the total number of the intersections with traffic signals sgj and stop lines ej is three.

Then, the CPU 31 reads the number of the intersections, refers to the guidance phrase map, and reads the guidance phrases corresponding to the calculated number of the intersections and the distances. The CPU 31 performs voice output of guidance phrases (S3) such as “Make a left turn at the third traffic signal,” or the like based on the calculated number of the intersections.

As described above, in the example, route guidance is performed based on the number of the intersections with both traffic signals sgj and stop lines. Accordingly, the driver can more easily determine which intersection is referred to in a voice guidance such as “the third intersection with the traffic signals,” and can correctly recognize the guide intersection.

While various features have been described in conjunction with the examples outlined above, various alternatives, modifications, variations, and/or improvements of those features and/or examples may be possible. Accordingly, the examples, as set forth above, are intended to be illustrative. Various changes may be made without departing from the broad spirit and scope of the underlying principles.

What is claimed is:

1. A route guidance system for a vehicle, comprising:
a controller that:
detects a current position of the vehicle;
searches for a route to a destination based on the detected current position;
identifies a guide intersection along the route;
sets a route guide point at a predetermined point on the route before the guide intersection;
calculates a number of intersections along the route from the route guide point to the guide intersection having both a traffic signal and a road feature; and
performs a voice output based on the calculated number of intersections when the vehicle arrives at the route guide point.

2. The route guidance system according to claim 1, wherein the controller:
calculates a number of intersections that have roads to enter and roads to exit on the searched route from the route guide point to the guide intersection.

3. The route guidance system according to claim 1, wherein the controller:
identifies an integrated intersection including two or more intersections as one intersection.

4. The route guidance system according to claim 1, wherein the road feature is a stop line.

5. The route guidance system according to claim 1, further comprising:
a memory storing traffic signal data and road feature data;
wherein the controller calculates the number of intersections along the route from the route guide point to the guide intersection having both a traffic signal and a road feature based on the stored traffic signal data and road feature data.

6. The route guidance system according to claim 5, further comprising:
a camera mounted on the vehicle that captures image data of a road surface;
wherein the controller:
performs image recognition on the image data to recognize road features;
based on the image recognition, if a road feature is recognized on the road surface which is not included in the stored road feature data, performs a voice output that notifies a user of the recognized road feature; and
stores the recognized road feature in the road feature data.

7. A navigation device comprising the route guidance system of claim 1.

8. A route guidance method, comprising:
detecting a current position of the vehicle;
searching for a route to a destination based on the detected current position;
identifying a guide intersection along the route;
setting a route guide point at a predetermined point on the route before the guide intersection;
calculating a number of intersections along the route from the route guide point to the guide intersection having both a traffic signal and a road feature; and
performing a voice output based on the calculated number of intersections when the vehicle arrives at the route guide point.

9. The route guidance method according to claim 8, further comprising:
calculating a number of intersections that have roads to enter and roads to exit on the searched route from the route guide point to the guide intersection.

10. The route guidance method according to claim 8, further comprising:
identifying an integrated intersection including two or more intersections as one intersection.

11. The route guidance method according to claim 8, wherein the road feature is a stop line.

12. The route guidance method according to claim 8, further comprising:
storing traffic signal data and road feature data; and
calculating the number of intersections along the route from the route guide point to the guide intersection having both a traffic signal and a road feature based on the stored traffic signal data and road feature data.

13. The route guidance method according to claim 12, further comprising:
capturing image data of a road surface;
performing image recognition on the image data to recognize road features;
based on the image recognition, if a road feature is recognized on the road surface which is not included in the stored road feature data, performing a voice output that notifies a user of the recognized road feature; and
storing the recognized road feature in the road feature data.

14. A computer-readable storage medium storing a computer-executable program usable to provide route guidance, the program comprising instructions that cause a computer to:
detect a current position of the vehicle;
search for a route to a destination based on the detected current position;
identify a guide intersection along the route;
set a route guide point at a predetermined point on the route before the guide intersection;
calculate a number of intersections along the route from the route guide point to the guide intersection having both a traffic signal and a road feature; and
perform a voice output based on the calculated number of intersections when the vehicle arrives at the route guide point.

15. The computer-readable storage medium according to claim 14, further comprising instructions that cause the computer to:
calculate a number of intersections that have roads to enter and roads to exit on the searched route from the route guide point to the guide intersection.

16. The computer-readable storage medium according to claim 14, further comprising instructions that cause the computer to:
identify an integrated intersection including two or more intersections as one intersection.

17. The computer-readable storage medium according to claim 14, wherein the road feature is a stop line.

18. The computer-readable storage medium according to claim 14, further comprising instructions that cause the computer to:
calculate the number of intersections along the route from the route guide point to the guide intersection having both a traffic signal and a road feature based on stored traffic signal data and road feature data.

19. The computer-readable storage medium according to claim 18, further comprising instructions that cause the computer to:
performs image recognition on captured image data to recognize road features;
based on the image recognition, if a road feature is recognized on the road surface which is not included in the stored road feature data, perform a voice output that notifies a user of the recognized road feature; and
store the recognized road feature in the road feature data.
